(19) United States
(12) Patent Application Publication
(10) Pub. No.: US 2026/0155305 A1
(43) Pub. Date: Jun. 4, 2026

(54) CAPACITOR AND METHOD OF MANUFACTURING THE SAME

(71) Applicant: RUBYCON CORPORATION, Nagano (JP)

(72) Inventors: Yuta ISHIHARA, Nagano (JP); Tomonao KAKO, Nagano (JP)

(73) Assignee: RUBYCON CORPORATION, Nagano (JP)

(21) Appl. No.: 18/851,592

(22) PCT Filed: Mar. 22, 2023
(86) PCT No.: PCT/JP2023/011157

§ 371 Date: Sep. 26, 2024

(30) Foreign Application Priority Data
Mar. 30, 2022 (JP) 2022-055453

(51) Int. Cl. H01G 4/232; H01G 4/18; H01G 4/30; H01G 4/32; H01G 13/00

(52) U.S. Cl. CPC H01G 4/2325; H01G 4/18; H01G 4/30; H01G 4/32; H01G 13/006

(57) ABSTRACT

There is provided a capacitor including: a main body in which a dielectric layer made of thermosetting resin and an electrode layer made of metal are laminated or wound; and an external electrode to which at least part of the main body is connected. The capacitor includes a metallikon region that is made of aluminum or an alloy containing aluminum, and a void ratio VR of at least a boundary region of the metallikon region that contacts the dielectric layer made of thermosetting resin and the electrode layer made of metal satisfies the following condition: 0<VR≤11%.

### TECHNICAL FIELD

The present invention relates to a capacitor and a method of manufacturing the same.

### BACKGROUND ART

Japanese Laid-open Patent Publication No. 2021-19133 discloses a thin-film polymer multilayer capacitor that includes: a chip-shaped multilayered structure in which dielectric layers and internal electrode layers, which include a first metal layer formed by vapor-depositing a first metal on a dielectric layer and second metal layer formed by vapor-depositing a second metal on the first metal layer, are alternately laminated and bonded; and external electrodes which are formed at one end and another end of the multilayered structure, wherein the multilayered structure includes a first region, in which the first metal is formed on the dielectric layer and alternately stacked, and edge regions where the second metal layers are formed on layers connected to the one end and the other end of the first metal layer and alternately stacked, the first region includes a capacitor functional region, and heavy edges are formed in the edge regions.

### SUMMARY OF INVENTION

One example of a polymer multi-thin-layer capacitor (hereinafter “PML”) includes a main body (main body portion, capacitor body, capacitor element) made by laminating (stacking, layering) metal electrode layers formed by vapor-depositing aluminum and layers formed by highly heat-resistant thermosetting resin, such as acrylic resin or methacrylic resin (as examples, tricyclodecane dimethanol dimethacrylate or tricyclodecane dimethanol diacrylate) as dielectric layers. A PML further includes external electrodes connected to ends of the main body, with connected parts of the external electrodes that are connected to the main body including a layer (metallikon layer) formed by spraying (thermal metallic spraying, being metalized, metallikon) molten metal. In a conventional film capacitor in which a main body portion is manufactured by winding a dielectric layer and an electrode layer, external electrodes including a metallikon layer are provided to connect the main body portion to an external circuit.

Although it is possible to use various metals or alloys as the metallikon metal that forms the metallikon layer, since molten metal is sprayed onto the main body, deterioration of resin-based dielectric layers can be a problem. One example of a metallikon metal is brass (Cu+Zn), which has a high melting point, is easily adapted to the reflow process, and is also easy to be plated for forming the exterior of the external electrode. However, metallikon layers made of brass are formed with a sufficient distance (spraying distance) to avoid or reduce the influence on the dielectric layers. Another example of a metallikon metal is zinc, which has a low melting point and therefore has an effect of suppressing thermal degradation during thermal spraying.

Yet another example of a metallikon metal is aluminum, which has excellent adhesion to the electrode layers inside the main body and favorable moisture resistance. When used as a metallikon metal, aluminum is alloyed to lower the melting point, but there are no reports on conditions that would contribute to improved performance as evaluated by equivalent series resistance (ESR), loss (tan 8), and the like.

In recent years, there is demand for capacitors with an even higher withstand voltage and a lower ESR. When the electrode layers of a main body (capacitor element) are made thinner to sufficiently increase the surface resistivity (sheet resistivity) and thereby increase the withstand voltage, the connected parts will also become thinner. For this reason, there is demand for capacitors with even lower connection resistance at the connected parts and a sufficiently small ESR.

One aspect of the present invention is a capacitor including: a main body in which a dielectric layer made of thermosetting resin and an electrode layer made of metal are laminated (stacked) or wound; and an external electrode to which at least part of the main body is connected. The external electrode includes a metallikon region that is made of aluminum or an alloy containing aluminum and a void ratio VR of at least a boundary region of the metallikon region that contacts the dielectric layer made of thermosetting resin and the electrode layer made of metal satisfies the Condition (1) below:

$$0 < V R \leq 11 \% . \qquad ( 1 )$$

In the past, when forming external electrodes with metallikon (metalizing, thermal metal spraying) during the manufacturing of capacitors, typically film capacitors, attention has been paid to concerns over thermal degradation of the dielectric layers. For this reason, when forming a metallikon region, efforts have been made to suppress increases in resistance due to thermal degradation, particularly at the connected part (boundary part) between the main body and the metallikon region, with methods such as suppressing the spraying (thermal spray) temperature to a certain temperature or below and keeping the spraying distance at a certain distance or longer being studied. Conversely, the inventors of the present application have found that for a main body that uses dielectric layers made of thermosetting resin, rather than being concerned about thermal degradation of the dielectric layers, it is possible to improve the performance of a capacitor as evaluated by ESR by improving the density (that is, the compactness or denseness) of the metallikon, and in particular a boundary region of the metallikon region in contact with the dielectric layer and the electrode layer. That is, contrary to conventional technology, the inventors have found that the denseness of the metallikon region can be improved by methods such as raising the temperature at which metal is sprayed to form the boundary region of the metallikon region or by shortening the spraying distance, and as a result, the performance of the capacitor can be improved. In addition, the inventors of the present application have found that the denseness of the metallikon region can be evaluated, for example, by the void ratio VR of the metallikon region. The upper limit of Condition (1) may be 8%.

That is, in the past, when forming (manufacturing) external electrodes with metallikon, deterioration in performance was prevented by suppressing temperature rises of the main body. However, the inventors of the present application found that when aluminum or aluminum alloy is used as the metallikon metal in a capacitor provided with dielectric layers made of thermosetting resin, conversely raising the temperature of the boundary region (connection region) between the main body and the metallikon region improves performance, as indicated by ESR.

Another aspect of the present invention is a method of manufacturing a capacitor including: manufacturing a main body in which a dielectric layer made of thermosetting resin and an electrode layer made of metal are laminated (stacked, layered) or wound; and forming an external electrode connected to at least a part of the main body, wherein forming the external electrode includes forming a metallikon region by thermal spraying aluminum or an alloy containing aluminum so as to contact the main body, and when forming at least a boundary region of the metallikon region that contacts the dielectric layer made of thermosetting resin and the electrode layer made of metal, the temperature (surface temperature) is kept at at least 150° C. The temperature of the boundary region may be kept at 180° C. or higher.

The conditions for forming the metallikon region may be controlled by the spraying distance in place of or in addition to the temperature of the boundary region. That is, another aspect of the present invention is a method of manufacturing a capacitor including: manufacturing a main body in which a dielectric layer made of thermosetting resin and an electrode layer made of metal are laminated (stacked, layered) or wound; and forming an external electrode connected to at least a part of the main body, wherein forming the external electrode includes forming a metallikon region by thermal spraying aluminum or an alloy containing aluminum so as to contact the main body, and a spraying distance when forming at least a boundary region of the metallikon region that contacts the dielectric layer made of thermosetting resin and the electrode layer made of metal is kept at a maximum of 200 mm. The spraying distance may be 150 mm or less. Such conditions are important for providing a capacitor that satisfies Condition (1) given above.

The capacitor according to the present invention may be provided with a metallikon region including at least 80% of aluminum as the metallikon region connected to the main body. This makes it possible to provide a low resistance capacitor with favorable connections to the electrode layer of the main body. The metallikon region may be 100% aluminum or may include another component, such as silicon, in a range that satisfies the above condition. The electrode layer made of metal in the main body may be made of aluminum or made of an alloy including aluminum, which makes it possible to suppress detachment and/or deformation due to dissimilar metals.

The thermosetting resin dielectric layer may include at least one of acrylic resin and methacrylic resin. The dielectric layer made of thermosetting resin may have a thickness of 1.5 μm or less (that is, a maximum of 1.5 μm). The external electrode may further include an outer metallikon region provided in contact with the outside of the inner metallikon region that contacts the main body, the outer metallikon region being made of a metal or alloy that differs from the inner metallikon region.

### BRIEF DESCRIPTION OF DRAWINGS

FIG. 1 depicts an overview of a capacitor.

FIG. 2 is a flowchart depicting the manufacturing process of a capacitor.

FIG. 3 is a table indicating evaluation results of an embodiment and reference examples.

FIG. 4 is a table indicating the composition of metallikon.

FIG. 5 depicts a void ratio.

### DESCRIPTION OF EMBODIMENTS

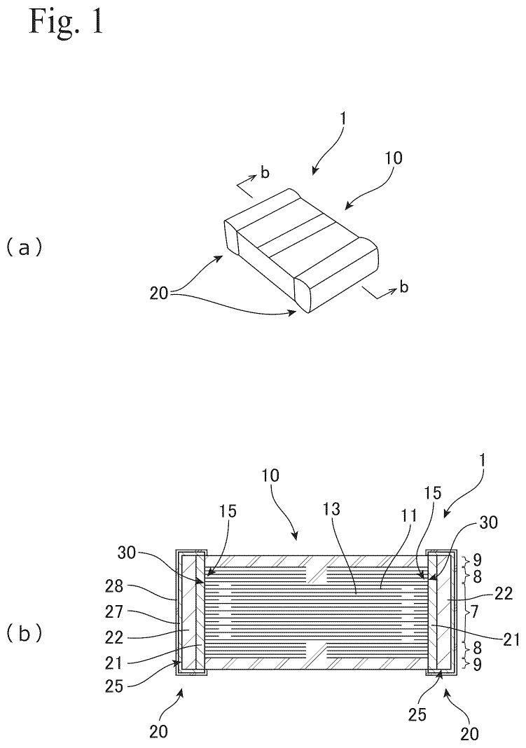

FIG. 1 depicts one example of a capacitor according to the present invention. A capacitor 1 whose appearance is depicted in FIG. 1(a) is one example of polymer multi-thin-layer capacitors (Polymer Multi-Layer capacitor, hereinafter referred to simply as the “PML) and includes a main body (main body portion, multilayer body, multilayer product, condenser body, or capacitor element) 10, in which dielectric layers 13 and electrode layers 11 are integrally laminated (stacked, layered) alternatively, and external electrodes 20 which are connected to the main body 10. As depicted in the cross-sectional view in FIG. 1(b), the main body 10 includes active layers 7 that exhibit a capacitance and are provided at the center in the thickness direction, dummy layers 8 that do not exhibit a capacitance and are disposed above and below the active layers 7, and protective layers 9 that are disposed above and below the dummy layers 8. The active layers 7 and the dummy layers 8 are constructed by stacking resin layers (dielectric layers) 13 and electrode layers 11, and the protective layers 9 are composed of resin only. The external electrodes 20 are formed so as to be joined to the electrode layers 11 and the resin layers 13 of the active layers 7 and the dummy layers 8, and include an internal metallikon layer 25, a copper plating layer 27 that covers the periphery of the metallikon layer 25, and a tin plating layer 28 that further covers the outside.

Each metallikon layer 25 includes an inner region (inner layer or first metallikon region) 21 that contacts the dielectric layers 13 and the electrode layers 11 of the main body 10, and an outer region (outer layer or second metallikon region) 22 provided on the outside of the inner region 21. The first metallikon region 21 includes a boundary region 30 where a metallikon metal (first metallikon metal, first metal for metallikon, first metal for metalizing) is thermal sprayed onto a boundary surface 15 that is a cut surface of the main body 10. In the present embodiment, the first metallikon metal is aluminum or an aluminum-based alloy, and the first metallikon region 21 includes the boundary region 30 made of aluminum or an alloy containing aluminum that contacts the main body 10. The metallikon layer 25 may be entirely made of the same metal, as one example, aluminum. On the other hand, the first metallikon region 21 on the inside may be formed by a material and/or method that prioritizes connection performance with the main body 10, and the second metallikon region 22 on the outside may be formed by a material and/or method that prioritizes connection performance with the outside. The second metallikon region 22 may be formed of a material, such as brass, that strongly adheres to the outer plating layer 27 and high thermal resistance during reflowing. The second metallikon region 22 may be copper, tin, zinc, or an alloy containing any of these.

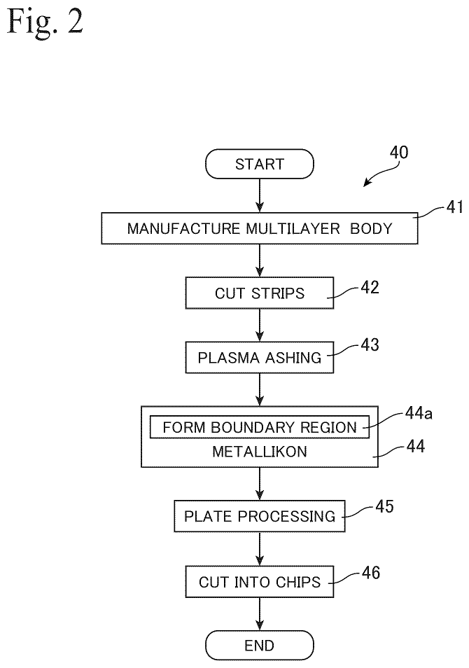

FIG. 2 depicts one example of a manufacturing method of the PML 1. One example specification of the PML 1 is as follows.
Rated voltage: 63V
Capacitance: 2.2 μF
Capacitor size: 5.7×5.0×1.73 mm (W×D×H)
Thickness of electrode layer 11: 15 nm
Material of electrode layer 11: Aluminum (Al)
Thickness of dielectric layer 13: 0.6 μm
Material of dielectric layer 13: Thermosetting resin (methacrylic resin)
(for example, tricyclodecane dimethanol dimethacrylate)
Vapor deposition resistance: 12 to 13 Ω/square (Ω/sq.)
Thickness of first metallikon region 21: 60 to 80 μm
Material of first metallikon region 21: aluminum (Al 99.99%) or aluminum silicon alloy
(Al 88%+Si 12%)
Thickness of second metallikon region 22: 120 to 140 μm
Material of second metallikon region 22: Brass (Cu 65%+Zn 35%)

In the manufacturing method 40 depicted in FIG. 2, in step 41, a multilayer body (multilayer structure, laminate structure) that forms the base of the main body (main body portion) 10 is manufactured. One example of a method for manufacturing the multilayer body is a method in which each layer is formed by vapor deposition, and there is a known apparatus that manufactures a multilayer body that will form the base of the main body 10 by forming the dielectric layers 13 and the electrode layers 11 on top of each other (alternatively) by vapor deposition on a drum that rotates in a reduced pressure environment (vacuum environment) in a vacuum chamber. The multilayer body may be manufactured using a different method, such as coating or printing. In the present embodiment, thermosetting resin applied as the dielectric layer 13 is cured by an electron beam irradiation apparatus or the like to form a thin layer (film) as the dielectric layer 13. In addition, the surface of each dielectric layer 13 is plasma-treated by a plasma treatment device in preparation for the next process. Before forming an electrode layer 11, oil margins for patterning the electrode layer 11 may be applied onto a dielectric layer 13 by a patterning unit. When using an already fabricated material, such as a film, as the dielectric layer like in a film capacitor, the step of forming dielectric layers may not be required, and may be performed separately from the step of forming the electrode layers.

In step 42, the multilayer body is cut into strips to form main body portions 10 in the form of strips (sticks). The strip-like main body portions 10 may be formed directly from the multilayer body, or the strip-like main body portions 10 may be manufactured via other processes, such as flattening with a press and a card cutting process. In step 43, the cut surfaces are subjected to plasma ashing to form connecting parts (connection surfaces) 15 that are to be connected to the external electrodes 20. As one example, plasma ashing may be performed with a mixture of oxygen and carbon tetrafluoride gases to form the connecting parts 15 between the metallikon region and the internal electrodes. Through plasma ashing, any dielectric present at the cut surfaces produced by cutting into strips can be burned off, exposing the internal electrodes (that is, the electrode layers) 11.

In step 44, an external electrode 20 is formed by metallikon (that is, metal spraying) on the connecting surfaces 15 that have been subjected to plasma ashing. In the present embodiment, as described above, Al or an Al-based alloy (as one example, Al+Si) is sprayed onto the connecting surfaces 15 as a first metallikon metal to form the first metallikon region (metallikon layer) 21. In an initial stage 44a of this process, a boundary region 30 that contacts the dielectric layers 13 made of thermosetting resin and the electrode layers 11 made of metal that appear at the connecting surface 15 is formed. After this, brass is sprayed as a second metallikon metal to form the second metallikon region (second metallization layer) 22.

In step 45, a copper plating layer 27 and a tin plating layer 28 are formed in that order by electrolytic plating or the like. The tin plating layer 28 is effective in improving the solder wettability of the external electrodes 20. After this, any other processes that are required, such as heat treatment, are performed on the external electrodes 20. Then, in step 46, the main body portions 10 in strip form on which the external electrodes 20 have been formed are cut into chips together with the external electrodes 20, thereby manufacturing PMLs 1 in which the external electrodes 20 are connected to a main body 10. Note that the processes depicted in FIG. 2 are representative processes, and other processes may also be performed.

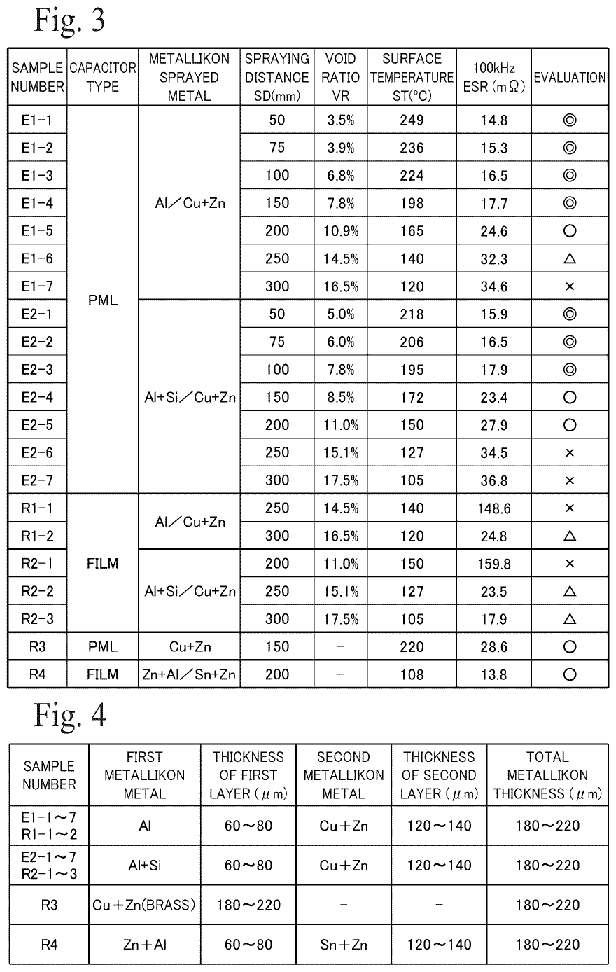

FIG. 3 depicts the results of manufacturing several samples by changing the spraying conditions for the metallikon regions in step 44, in particular the first metallikon region 21, and evaluating the performance of such samples based on ESR measurements. The samples E1-1 to E1-7 have the first metallikon region 21 formed of aluminum (hereinafter referred to as Al, (99.99% Al)) with the spraying distance SD being varied in a range of 50 to 300 mm. The samples E2-1 to E2-7 have the first metallikon region 21 formed of an aluminum-silicon alloy (hereinafter referred to as “Al+Si” (Al 88%+Si 12%)) with the spraying distance SD being varied in a range of 50 to 300 mm. The remaining specification is as described earlier.

As examples where the dielectric layers are made of a thermoplastic resin, the results of evaluating the performance of samples R1-1 to R1-2 and R2-1 to R2-3 in which the external electrodes of a film capacitor were made of Al or “Al+Si” under the same conditions as described above are depicted. Also the results of evaluating the performance of a sample R3 where the external electrodes 20 of the PML 1 are formed by brass metallikon, and a sample R4 where the external electrodes of a film capacitor are formed by two-layer metallikon composed of zinc-aluminum alloy (hereinafter referred to as “Zn+Al”, (Zn 95%+Al 5%)) and tin-zinc alloy (hereinafter referred to as “Sn+Zn”, (Sn 80%+Zn 20%)) are shown. The specifications of the film capacitor used in this evaluation are as follows:
Rated voltage: 630V
Capacitance: 10 μF
Capacitor size: 22.5×10.5×17.0 mm (W×D×H)
Thickness of electrode layer: 25 nm
Material of electrode layer: Aluminum (Al)
Thickness of dielectric layer: 5 μm
Material of dielectric layer: Thermoplastic resin (polypropylene)
Vapor deposition resistance: 3 Ω/sq.
Thickness of first metallikon region: 60 to 80 μm
Material of first metallikon region: aluminum (Al 99.99%) or aluminum-silicon alloy
(Al 88%+Si 12%)
Thickness of second metallikon region: 120 to 140 μm
Material of second metallikon region: brass (Cu 65%+Zn 35%)

The specifications of the metallikon layer of each sample are collectively indicated in FIG. 4. The spraying (thermal spraying, heat spraying) conditions for each sample were as follows:
Spraying method: Wire electric arc spraying
Air pressure: 0.39 to 0.47 MPa
Sprayed material: Wire with a diameter of 1.2 mm, with the following compositions:

$$Al : ( Al 99.99 \% )$$

$$Al + Si : ( Al 88 \% + Si 12 \% )$$

$$Brass : ( Cu 65 \% + Zn 35 \% )$$

$$Zn + Al : ( Zn 95 \% + Al 5 \% )$$

$$Sn + Zn : ( Sn 80 \% + Zn 20 \% )$$

The surface temperature ST in FIG. 3 indicates the temperature of the surface (spraying contact surface, connecting surface, or boundary surface) 15 contacted by the sprayed metal, and is a value that represents the temperature of the boundary region 30 when the sprayed metal forms the metallikon region 21. The temperature of the boundary surface 15 is a value measured by a thermocouple attached to the boundary surface 15. The “void ratio” VR indicates the value obtained by observing a cross-section with a digital microscope (as one example, VHX-5000 manufactured by Keyence Corporation) after the PML 1 including the external electrodes 20 has been manufactured by forming the metallikon regions 21 and 22 by spraying (thermal spraying) metal under the predetermined conditions described above and the external electrodes 20 including the main body portion 10 have then been cut.

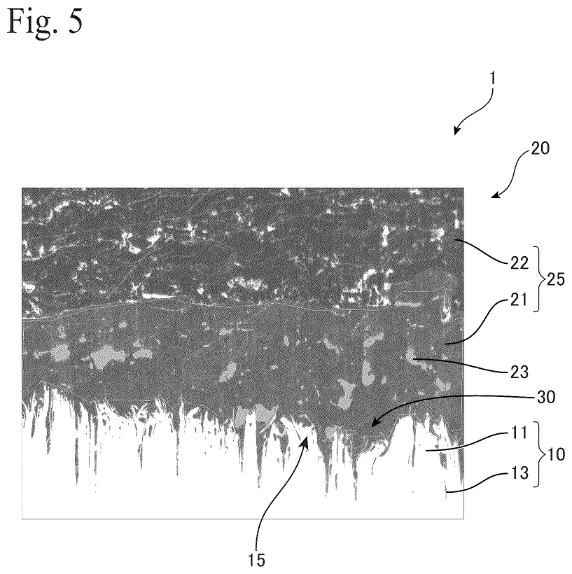

One example of an observed image is depicted in FIG. 5. In the present embodiment, the observation magnification was 1000 times, and voids 23 with a representative length of 0.15 μm or more were detected. The void ratio VR (%) was calculated using Equation (2) below. Averages of the values observed at at least three locations on the cross-section are shown in FIG. 3.

$$Void ratio V R ( \% ) = ( total void area / total observation area ) \times 100 \qquad ( 2 )$$

The ESR values indicated in FIG. 3 are values measured after the PML was completed as a capacitor. This is also the same for the film capacitors. Evaluation based on the results of the measured ESR (at 100 kHz) was performed as follows for the PML 1 and the film capacitors, based on the measured ESR values of the commercially available samples R3 and R4.

### Evaluation of PML 1

⊚ (double circle mark (excellent)): ESR<20 mΩ:
∘ (single circle mark (good)): 20≤ESR<30 mΩ
Δ (triangle mark (fair)): 30≤ESR<33 mΩ
x (cross mark (poor)): 33 mΩ<ESR

### Evaluation of Film Capacitors

⊚ (double circle mark (excellent)): ESR<10 mΩ
∘ (single circle mark (good)): 10≤ESR<15 mΩ
Δ (triangle mark (fair)): 15≤ESR<30 mΩ
x (cross mark (poor)): 30 mΩ≤ESR

As depicted in FIG. 3, in the film capacitor-type samples R1-1 to R1-2 and R2-1 to R2-3 where thermoplastic resin is used for the dielectric layers 13, when the spray distance SD is shortened and the temperature of the boundary surface 15 increases, the void ratio VR of the metallikon region 21 made of Al or “Al+Si”, including the boundary region 30 in contact with the boundary surface 15, decreases and the denseness improves. However, it was discovered that the ESR value increases, which means lower performance as a capacitor.

On the other hand, for the PML-type samples E1-1 to E1-7 and E2-1 to E2-7, in which a thermosetting resin is used for the dielectric layers 13, when the spraying distance SD is shortened and the metallikon region 21, including the boundary region 30, is formed so that the temperature of the boundary surface 15 increases, the void ratio VR of the metallikon region 21 made of Al or “Al+Si”, including the boundary region 30 in contact with the boundary surface 15, decreases and the denseness improves. At the same time, the ESR value decreases, which lowers the resistance and improves the performance as a capacitor.

In this way, based on the evaluation results in FIG. 3, it was understood that for capacitors (that is, the samples E1-1 to E1-7 and the samples E2-1 to E2-7) that include dielectric layers 13 made of thermosetting resin (formed or manufactured using thermosetting resin) and electrode layers 11 made of metal, compared to capacitors provided with dielectric layers made of thermoplastic resin (the samples R1-1 to R1-2 and the samples R2-1 to R2-3), the tendency for the performance as a capacitor and in particular the performance relating to the connection characteristics to improve is reversed depending on the formation method or characteristics of the metallikon region 21. For samples with dielectric layers made of thermosetting resin, when focusing on the void ratio VR of the inner metallikon region 21 in contact with the main body 10, it was understood that when the metallikon region 21, including the boundary region 30 that makes contact with the connection surface 15 where the dielectric layers 13 made of thermosetting resin and the electrode layers 11 made of metal appear, is made of Al or “Al+Si”, a low-resistance and low-loss capacitor can be obtained when the void ratio VR is 11% or below. In addition, it was found that if the void ratio VR is 8% or below, the ESR value decreases further, so that a capacitor with extremely low loss and excellent performance can be provided. On the other hand, in the samples with dielectric layers made of thermoplastic resin, even if the metallikon region 21 is formed using Al or “Al+Si” under the same conditions, favorable overall performance cannot be obtained. In particular, as the void ratio VR falls, the performance tends to deteriorate, and when the void ratio VR falls below around 14%, the resistance becomes too high, which makes it difficult to use Al or “Al+Si” as the metal for the metallikon.

By focusing on the parameters for manufacturing a capacitor, for PML 1, it was understood that a low-resistance, low-loss capacitor can be provided by forming the metallikon region 21 by spraying Al or “Al+Si” at a spraying distance SD of 200 mm or less, including the boundary region 30 adjacent to the connection surface 15 where the dielectric layers 13 made of thermosetting resin and the electrode layers 11 made of metal appear. It was understood that a capacitor with an even higher evaluation rating can be provided if the spraying distance SD is 150 mm or less. Focusing on the temperature ST of the surface (boundary surface) 15 to be sprayed, it was understood that a low-resistance, low-loss capacitor can be provided by spraying Al or “Al+Si” to form a metallikon region 21 so that the surface temperature ST, which is the temperature at which the boundary region 30 is formed, is 150° C. or higher. It was understood that a capacitor with an even higher evaluation rating can be provided if the surface temperature ST is 180° C. or higher.

These results show that by forming the dielectric layers 13 of the main body 10 from a thermosetting resin and providing the external electrodes 20 with dense (highly compacted, denseness) metallikon regions, it is possible to provide a capacitor 1 that uses Al or an Al-based alloy as the metallikon metal. In particular, the above description indicates that a capacitor with superior characteristics can be provided by forming the metallikon region 21 using Al alone or an alloy containing (including) 80% or more Al as the metallikon metal. Accordingly, a capacitor that satisfies the above conditions and a manufacturing method thereof can provide a capacitor 1 that takes advantage of the characteristics of aluminum, has superior adhesion to the electrode layers 11 inside the main body, has low resistance and low loss, and also has favorable moisture resistance. There is also promise of an effect of suppressing corrosion that can be caused by dissimilar metals. Although an example of an “Al+Si” alloy has been described above as an Al-based alloy, it is assumed that similar characteristics can be obtained by Al-based alloys that contain other components.

In particular, if the metallic electrode layers 11 of the main body portion 10 are made of aluminum or an alloy containing aluminum, Al or an Al-based alloy can be sprayed (thermal sprayed) onto the boundary surface 15 to form a metallikon region 21 including the boundary region 30, thereby providing a capacitor 1 in which the electrode layers 11 of the main body portion 10 and the metallikon regions 21 of the external electrodes 20 have a common or similar composition, resulting in little risk of peeling, high durability, and excellent connection performance. Although tricyclodecane dimethanol dimethacrylate, which is one example of a methacrylic resin, is used as the thermosetting resin forming the dielectric layers 13 in the above description, other methacrylic resins may also be used. The thermosetting resin may be acrylic resin, with one example being tricyclodecane dimethanol diacrylate. It can also be assumed that similar characteristics will be obtained with other thermosetting resins so long as they can be used as dielectric layers. Although there are no particular limitations on the thickness of the dielectric layers 13 made of thermosetting resin, the thickness may be 1.5 μm or less (that is, a maximum of 1.5 μm) with consideration to a thickness that can be uniformly controlled by vapor deposition.

In the example described above, in addition to the inner metallikon regions 21 made of Al or “Al+Si” including the boundary region 30 in contact with the boundary surface 15, second metallikon regions 22 which are made of brass are provided on the outside. Each external electrode 20 may be formed of a single metallikon region, or may be formed of metallikon regions in three or more layers. Since a capacitor 1 with brass metallikon regions 22 has a high melting temperature and a high affinity with the plating layers that cover the external electrodes 20, this is a favorable example configuration for a surface mount device (SMD) that is attached by reflowing process or the like.

As described above, the use, as the outer electrodes of a film capacitor, of aluminum or an aluminum-based alloy for the metallikon as the inner layer (first layer or inside part) including the boundary region 30 which serves as the lead-outs of the electrodes has the following advantages when aluminum is used as the inner electrodes. The use of the same metal is expected to improve connectivity and moisture resistance and is sometimes proposed for this reason. However, conventional film capacitors use thermoplastic resin, such as PET or PP (PPS, PEN) as the dielectric material, and such materials have low melting points. For this reason, thermal degradation is likely to occur during metallization (metallikon process), and when aluminum-based metallikon with a relatively high melting point is used, it is necessary to suppress thermal degradation of the film. To address this issue, methods have been proposed to lower the temperature of the metal particles when the aluminum-based metallikon adheres to the film, such as increasing the metallization distance (spraying distance) and allowing the metallikon metal to lower the melting point. However, lowering the temperature of the metal particles during adhesion reduces the adhesion for the metallikon coating, which in turn weakens the connections with the internal electrodes, so that it is no longer possible to improve capacitor characteristics such as ESR, and difficult to provide a capacitor that provides the benefits of using aluminum.

By using a highly heat-resistant thermosetting resin for the dielectric layers 13, it is expected that thermal degradation of the dielectric layers 13 due to aluminum-based metallikon will be reduced, even if the metallikon (first metallikon region) 21, including the boundary region 30 that serves as the lead-outs of the electrodes, is formed using aluminum or an aluminum-based alloy. For this reason, it is believed that it is possible to form an aluminum-based metallikon layer while the temperature of the metallized particles remains high, and possible to obtain a low-resistance capacitor 1 with favorable connectivity to the internal electrodes 11. The present invention demonstrates this and also discloses the conditions for providing a low-resistance capacitor 1 that uses aluminum-based metallikon.

In particular, in a polymer multi-thin-layer capacitor (PML), which uses a thermosetting resin as the dielectric and has an extremely thin dielectric layers 13, it is necessary to drive the metallizing particles (metallikon particles) finely and forcefully in order to obtain sufficient connection performance between the external electrodes 20) and the main body portion 10. Accordingly, the ability to shorten the spraying distance (metallikon distance) SD is even more useful in the manufacturing of a PML. In addition, the present invention discloses that shortening the spraying distance SD can provide a capacitor 1 with low resistance and discloses that it is effective to spray metal from a short distance that would be unthinkable for a normal film capacitor. Accordingly, by using aluminum-based metallikon in the configuration described above in a polymer multi-thin-layer capacitor (PML), it is possible to provide a capacitor with more favorable characteristics than conventional metallikon, such as brass, zinc, or tin. Also, in the case of film capacitors, a similar effect can be obtained for a film capacitor (thermosetting film capacitor) that uses thermosetting resin as the dielectric layers (dielectric films).

In one example method of manufacturing a PML, the step 41 of manufacturing the multilayer body depicted in FIG. 2 includes a process of forming a multilayer body (main body) 10 which includes: a step of vapor-depositing a monomer, in the present embodiment, a thermosetting resin, in a vacuum chamber to form a monomer layer and then irradiating the monomer layer with an electron beam to cure the monomer layer and thereby form a dielectric layer 13 made of a thermosetting resin: a step of contactlessly applying margin oils to form margin portions; and a step of depositing a metal material, such as aluminum, to form a metal thin film layer (electrode layer) 11, with these steps being consecutively repeated on a rotating drum to alternately stack a thin resin layer 13 and a thin metal layer 11 on the rotating drum. After this, the multilayer body 10 can be cut and metallikon layers 21 of aluminum or an aluminum alloy can be formed as the external electrodes 20.

In polymer multi-thin-layer capacitors and film capacitors, the formation of heavy edges by laminating (stacking) aluminum or zinc at or near end portions (boundary surfaces) 15 of the electrode layers 11 of a main body (multilayer body) 10 is being studied. For such capacitors, it is effective to use thermosetting resin as the dielectric layers as described above, and also to use Al or an Al-based alloy as the metallikon metal to form a dense layer by spraying (irradiating) at a close distance or at a high temperature.

For metallikon (that is, the spraying of metal), as a general rule, the closer the distance (the higher the temperature), the better the adhesion. However, in the case of capacitors, such as film capacitors, with thermoplastic dielectric layers such as conventional polypropylene or polyethylene terephthalate, if the sprayed metal is too hot, the films may deform or melt. As a result, the bonding or connecting between the electrode layers inside the main body and the metallikon of the external electrode deteriorates, and in the case of aluminum or aluminum-based alloy, it was found that the deterioration in the bonding leads to a significant drop in performance.

In contrast, the present invention discloses that it becomes possible to suppress deterioration in bonding performance in a capacitor that uses a thermosetting resin in the dielectric layers, and also becomes possible to improve performance by forming a metallikon region using aluminum or an aluminum-based alloy. One of the reasons for this improved performance is believed to be the improvement in physical and electrical connectivity due to the electrode layers 11 of the main body 10 are made of aluminum and the metallikon regions 21 connected to such layers are made of aluminum-based metallikon, which enables the same type of metals to be bonded together at the connecting surface 15 and the boundary region 30. Another reason is that aluminum-based metallikon has higher electrical conductivity and can lower the resistance compared to zinc or brass, which are often used as metallikon in film capacitors. Also, since the temperature of the metallikon particles can be raised, the adhesion of the metallikon particles also increases accordingly. By forming external electrodes from metallikon in this state, it is believed that the connectivity between the internal electrode layers 11 and the external electrode 20 will improve and the resistance will fall.

Regarding adhesion, in addition to the ability to raise the particle temperature, one of the factors is believed to be that the electrode layers 11 of the main body 10 and the metallikon region 21 inside each external electrode 20 are made of the same metal. In this case, in addition to achieving a low resistance, corrosion (electrolytic corrosion) that would occur with dissimilar metals does not occur, so that there is also a further advantage that a capacitor with long-term reliability can be provided.

The above description discloses a capacitor including a main body in which dielectric layers made of a thermosetting resin and electrode layers made of metal are stacked or wound, and external electrodes to which at least part of the main body are connected, wherein the external electrodes include dense metallikon regions that are made of aluminum or an alloy containing aluminum and are regions in contact with the main body. The void ratio VR can be used as an index indicating denseness or the metallikon regions, and the void ratio VR of the metallikon region may satisfy the following condition.

$$0 < V R \leq 11 \% . \qquad ( 1 )$$

The metallikon region may contain at least 80% aluminum, the metallikon region may contain silicon, and the electrode layers made of metal may be made of aluminum or an alloy including aluminum. The dielectric layers made of thermosetting resin may include at least one of acrylic resin and methacrylic resin. The dielectric layers made of thermosetting resin may have a thickness of 1.5 μm or less, and the external electrodes may include a plurality of layers or regions, which may include an outer metallikon region that is provided in contact with an outside of an inner metallikon region and is made of a different metal or alloy than the inner metallikon region.

The above description discloses a method for manufacturing a capacitor. This method of manufacturing includes manufacturing a main body in which dielectric layers made of thermosetting resin and electrode layers made of metal are stacked or wound, and forming external electrodes connected to at least a part of the main body, wherein forming the external electrodes includes keeping the temperature of a boundary region between the main body and the metallikon region at at least 150° C. when forming the metallikon region by spraying aluminum or an alloy containing aluminum so as to contact the main body.

A different method for manufacturing a capacitor is also disclosed above. This method of manufacturing includes manufacturing a main body in which dielectric layers made of thermosetting resin and electrode layers made of metal are stacked or wound, and forming external electrodes connected to at least a part of the main body, wherein forming the external electrodes includes keeping a spraying distance when forming the metallikon region by spraying aluminum or an alloy containing aluminum so as to contact the main body portion at a maximum of 200 mm.

Note that although specific embodiments of the present invention have been described above, various other embodiments and modifications will be conceivable to those of skill in the art without departing from the scope and spirit of the invention. Such other embodiments and modifications are addressed by the scope of the patent claims given below, and the present invention is defined by the scope of these patent claims.

1. A capacitor comprising:
a main body in which a dielectric layer made of thermosetting resin and an electrode layer made of metal are laminated or wound; and
an external electrode to which at least part of the main body is connected,
wherein the external electrode includes a metallikon region that is made of aluminum or an alloy containing aluminum and a void ratio VR of at least a boundary region of the metallikon region that contacts the dielectric layer made of thermosetting resin and the electrode layer made of metal satisfies a following condition,
$$0 < V R \leq 11 \% .$$

2. The capacitor according to claim 1,
wherein the void ratio VR satisfies a following condition,
$$0 < V R \leq 8 \% .$$

3. The capacitor according to claim 1,
wherein the metallikon region includes at least 80% aluminum.

4. The capacitor according to claim 3,
wherein the metallikon region includes silicon.

5. The capacitor according to claim 1,
wherein the electrode layer made of metal is made of aluminum or an alloy including aluminum.

6. The capacitor according to claim 1,
wherein the dielectric layer made of thermosetting resin includes at least one of acrylic resin and methacrylic resin.

7. The capacitor according to claim 1,
wherein the thickness of the dielectric layer made of thermosetting resin is 1.5 μm or less.

8. The capacitor according to claim 1,
wherein the external electrode includes an outer metallikon region that is provided in contact with an outside of the metallikon region and is made of a metal or alloy that differs from the metallikon region.

9. A method of manufacturing a capacitor comprising:
manufacturing a main body in which a dielectric layer made of thermosetting resin and an electrode layer made of metal are laminated or wound; and
forming an external electrode connected to at least a part of the main body,
wherein forming the external electrode includes forming a metallikon region by spraying aluminum or an alloy containing aluminum so as to contact the main body, and
forming the metallikon region includes keeping a temperature of at least a boundary region that contacts the dielectric layer made of thermosetting resin and the electrode layer made of metal at at least 150° C.

10. A method of manufacturing a capacitor comprising:
manufacturing a main body in which a dielectric layer made of thermosetting resin and an electrode layer made of metal are laminated or wound; and
forming an external electrode connected to at least a part of the main body,
wherein forming the external electrode includes forming a metallikon region by spraying aluminum or an alloy containing aluminum so as to contact the main body, and
forming the metallikon region includes keeping a spraying distance when forming at least a boundary region that contacts the dielectric layer made of thermosetting resin and the electrode layer made of metal at a maximum of 200 mm.

11. The method of manufacturing a capacitor according to claim 9,
wherein a void ratio VR of the boundary region satisfies the following condition,
$$0 < V R \leq 11 \% .$$

12. The method of manufacturing a capacitor according to claim 9,
wherein the metallikon region includes at least 80% of aluminum.

13. The method of manufacturing a capacitor according to claim 9,
wherein the electrode layer made of metal is made of aluminum or an alloy including aluminum.

14. The method of manufacturing a capacitor according to claim 9,
wherein the dielectric layer made of thermosetting resin includes at least one of acrylic resin and methacrylic resin.

15. The method of manufacturing a capacitor according to claim 10,
wherein a void ratio VR of the boundary region satisfies the following condition,
$$0 < V R \leq 11 \% .$$

16. The method of manufacturing a capacitor according to claim 10,
wherein the metallikon region includes at least 80% of aluminum.

17. The method of manufacturing a capacitor according to claim 10,
wherein the electrode layer made of metal is made of aluminum or an alloy including aluminum.

18. The method of manufacturing a capacitor according to claim 10,
wherein the dielectric layer made of thermosetting resin includes at least one of acrylic resin and methacrylic resin.
